(19) United States
(12) Patent Application Publication
(10) Pub. No.: US 2006/0216571 A1
(43) Pub. Date: Sep. 28, 2006

(54) Metal oxide based hydrophilic coatings for PEM fuel cell bipolar plates

(76) Inventors: Gayatri Vyas, Rochester Hills, MI (US); Mahmoud H. Abd Elhamid, Grosse Pointe Woods, MI (US); Thomas A. Trabold, Pittsford, NY (US); Keith E. Newman, Pittsford, NY (US); Richard H. Blunk, Macomb Township, MI (US); Youssef M. Mikhail, Sterling Heights, MI (US); Reena L. Datta, Rochester, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/089,526

(22) Filed: Mar. 24, 2005

(51) Int. Cl. H01M 8/02; B05D 5/12

(52) U.S. Cl. 429/38; 427/115

(57) ABSTRACT

A flow field plate for a fuel cell that includes a metal oxide coating that makes the plate hydrophilic. In one embodiment, the metal oxide coating is a thin film to maintain the conductive properties of the flow field plate. The metal oxide can be combined with a conductive oxide. According to another embodiment, the metal oxide coating is deposited as islands on the flow field plate so that the flow field plate is exposed between the islands. According to another embodiment, lands between the flow channels are polished to remove the metal oxide layer and expose the flow field plate. According to another embodiment, the flow field plate is blasted with alumina so that embedded alumina particles and the roughened surface of the plate provide the hydrophilicity.

### BACKGROUND OF THE INVENTION

1. Field of the Invention

This invention relates generally to bipolar plates for fuel cells and, more particularly, to a bipolar plate for a fuel cell that includes a metal oxide layer deposited on the plate that makes the plate hydrophilic.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated in the anode to generate free protons and electrons. The protons pass through the electrolyte to the cathode. The protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid-polymer-electrolyte proton-conducting membrane, such as a perfluorosulfonic acid membrane. The anode and cathode typically include finely divided catalytic particles, usually platinum (Pt), supported on carbon particles and mixed with an ionomer. The catalytic mixture is deposited on opposing sides of the membrane. The combination of the anode catalytic mixture, the cathode catalytic mixture and the membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Several fuel cells are typically combined in a fuel cell stack to generate the desired power. For the automotive fuel cell stack mentioned above, the stack may include about two hundred bipolar plates. The fuel cell stack receives a cathode reactant gas, typically a flow of air forced through the stack by a compressor. Not all of the oxygen is consumed by the stack and some of the air is output as a cathode exhaust gas that may include water as a stack by-product. The fuel cell stack also receives an anode hydrogen reactant gas that flows into the anode side of the stack.

The fuel cell stack includes a series of flow field or bipolar plates positioned between the several MEAs in the stack. The bipolar plates include an anode side and a cathode side for adjacent fuel cells in the stack. Anode gas flow channels are provided on the anode side of the bipolar plates that allow the anode gas to flow to the anode side of the MEA. Cathode gas flow channels are provided on the cathode side of the bipolar plates that allow the cathode gas to flow to the cathode side of the MEA. The bipolar plates also include flow channels through which a cooling fluid flows.

The bipolar plates are typically made of a conductive material, such as stainless steel, titanium, aluminum, polymeric carbon composites, etc., so that they conduct the electricity generated by the fuel cells from one cell to the next cell and out of the stack. Metal bipolar plates typically produce a natural oxide on their outer surface that makes them resistant to corrosion. However, the oxide layer is not conductive, and thus increases the internal resistance of the fuel cell, reducing its electrical performance. Also, the oxide layer makes the plate more hydrophobic.

US Patent Application Publication No. 2003/0228512, assigned to the assignee of this application and herein incorporated by reference, discloses a process for depositing a conductive outer layer on a flow field plate that prevents the plate from oxidizing and increasing its ohmic contact. U.S. Pat. No. 6,372,376, also assigned to the assignee of this application, discloses depositing an electrically conductive, oxidation resistant and acid resistant coating on a flow field plate. US Patent Application Publication No. 2004/0091768, also assigned to the assignee of this application, discloses depositing a graphite and carbon black coating on a flow field plate for making the flow field plate corrosion resistant, electrically conductive and thermally conductive.

As is well understood in the art, the membranes within a fuel cell need to have a certain relative humidity so that the ionic resistance across the membrane is low enough to effectively conduct protons. During operation of the fuel cell, moisture from the MEAs and external humidification may enter the anode and cathode flow channels. At low cell power demands, typically below 0.2 A/cm², water accumulates within the flow channels because the flow rate of the reactant gas is too low to force the water out of the channels. As the water accumulates, it forms droplets that continue to expand because of the hydrophobic nature of the plate material. The contact angle of the water droplets is generally about 90° in that the droplets form in the flow channels substantially perpendicular to the flow of the reactant gas. As the size of the droplets increases, the flow channel is closed off, and the reactant gas is diverted to other flow channels because the channels flow in parallel between common inlet and outlet manifolds. Because the reactant gas may not flow through a channel that is blocked with water, the reactant gas cannot force the water out of the channel. Those areas of the membrane that do not receive reactant gas as a result of the channel being blocked will not generate electricity, thus resulting in a non-homogenous current distribution and reducing the overall efficiency of the fuel cell. As more and more flow channels are blocked by water, the electricity produced by the fuel cell decreases, where a cell voltage potential less than 200 mV is considered a cell failure. Because the fuel cells are electrically coupled in series, if one of the fuel cells stops performing, the entire fuel cell stack may stop performing.

It is usually possible to purge the accumulated water in the flow channels by periodically forcing the reactant gas through the flow channels at a higher flow rate. However, on the anode side, this increases the parasitic power applied to the air compressor, thereby reducing overall system efficiency. Moreover, there are many reasons not to use the hydrogen fuel as a purge gas, including reduced economy, reduced system efficiency and increased system complexity for treating elevated concentrations of hydrogen in the exhaust gas stream.

Reducing accumulated water in the channels can also be accomplished by reducing inlet humidification. However, it is desirable to provide some relative humidity in the anode and cathode reactant gases so that the membrane in the fuel cells remains hydrated. A dry inlet gas has a drying effect on the membrane that could increase the cell's ionic resistance, and limit the membrane's long-term durability.

It has been proposed by the present inventors to make bipolar plates for a fuel cell hydrophilic to improve channel water transport. A hydrophilic plate causes water in the channels to form a thin film that has less of a tendency to alter the flow distribution along the array of channels connected to the common inlet and outlet headers. If the plate material is sufficiently wettable, water transport through the diffusion media will contact the channel walls and then, by capillary force, be transported into the bottom corners of the channel along its length. The physical requirements to support spontaneous wetting in the corners of a flow channel are described by the Concus-Finn condition, β+α/2<90°, where β is the static contact angle and α is the channel corner angle. For a rectangular channel α/2=45°, which dictates that spontaneous wetting will occur when the static contact angle is less than 45°. For the roughly rectangular channels used in current fuel cell stack designs with composite bipolar plates, this sets an approximate upper limit on the contact angle needed to realize the beneficial effects of hydrophilic plate surfaces on channel water transport and low load stability.

### SUMMARY OF THE INVENTION

In accordance with the teachings of the present invention, a flow field plate or bipolar plate for a fuel cell is disclosed that includes a metal oxide coating that makes the plate hydrophilic. Suitable metal oxides include at least one of SiO₂, HfO₂, ZrO₂, Al₂O₃, SnO₂, Ta₂O₅, Nb₂O₅, MoO₂, IrO₂, RuO₂, metastable oxynitrides, nonstoichiometric metal oxides, oxynitrides and mixtures thereof. In one embodiment, the metal oxide coating is a very thin film so that the conductive properties of the flow field plate material allow electricity to be suitably conducted from fuel cell to fuel cell. According to another embodiment, the metal oxide coating is combined with a conductive oxide to provide both the hydrophilicity and the conductivity. According to another embodiment, the metal oxide coating is deposited as islands on the flow field plate so that the flow field plate is exposed between the islands to allow electricity to be conducted through the fuel cell. According to another embodiment, lands between the flow channels are polished to remove the metal oxide layer and expose the flow field plate so that the flow channels are hydrophilic and the lands are able to conduct electricity through the fuel cell. According to another embodiment, the flow field plate is blasted with alumina so that embedded alumina particles and a roughened surface of the plate provide the hydrophilicity, and the plate remains suitably conductive.

Additional advantages and features of the present invention will become apparent from the following description and appended claims, taken in conjunction with the accompanying drawings.

### BRIEF DESCRIPTION OF THE DRAWINGS

FIG. 1 is a cross-sectional view of a fuel cell in a fuel cell stack that includes bipolar plates having a metal oxide layer to make the plate hydrophilic, according to an embodiment of the present invention;

FIG. 2 is a broken-away, cross-sectional view of a bipolar plate for a fuel cell including a metal oxide layer defined by islands of the metal oxide separated by open areas, according to another embodiment of the present invention;

FIG. 3 is a broken-away, cross-sectional view of a bipolar plate for a fuel cell including a metal oxide layer, where the metal oxide layer has been removed at the lands between the flow channels in the plate, according to another embodiment of the present invention;

FIG. 4 is a broken-away, cross-sectional view of a bipolar plate for a fuel cell where an outer layer of the plate has been blasted with alumina to make the surface of the plate more textured and provide embedded alumina to make the plate hydrophilic, according to another embodiment of the present invention; and

FIG. 5 is a plan view of a system for depositing the various layers on the bipolar plates of the invention.

### DETAILED DESCRIPTION OF THE EMBODIMENTS

The following discussion of the embodiments of the invention directed to bipolar plates for a fuel cell that include an outer metal oxide layer that makes the bipolar plate hydrophilic is merely exemplary in nature, and is in no way intended to limit the invention or its applications or uses.

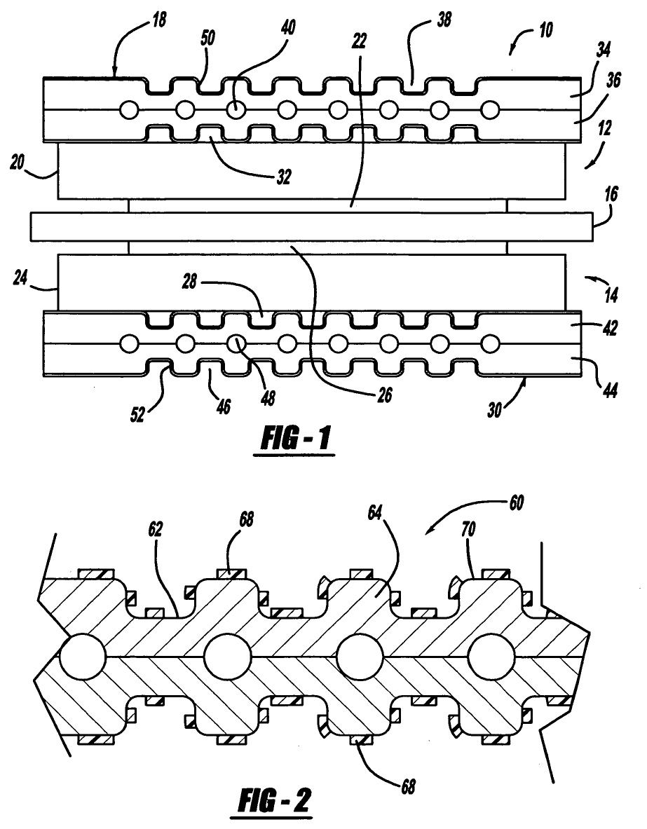

FIG. 1 is a cross-sectional view of a fuel cell 10 that is part of a fuel stack of the type discussed above. The fuel cell 10 includes a cathode side 12 and an anode side 14 separated by an electrolyte membrane 16. A cathode side diffusion media layer 20 is provided on the cathode side 12, and a cathode side catalyst layer 22 is provided between the membrane 16 and the diffusion media layer 20. Likewise, an anode side diffusion media layer 24 is provided on the anode side 14, and an anode side catalyst layer 26 is provided between the membrane 16 and the diffusion media layer 24. The catalyst layers 22 and 26 and the membrane 16 define an MEA. The diffusion media layers 20 and 24 are porous layers that provide for input gas transport to and water transport from the MEA. Various techniques are known in the art for depositing the catalyst layers 22 and 26 on the diffusion media layers 20 and 24, respectively, or on the membrane 16.

A cathode side flow field plate or bipolar plate 18 is provided on the cathode side 12 and an anode side flow field plate or bipolar plate 30 is provided on the anode side 14. The bipolar plates 18 and 30 are provided between the fuel cells in the fuel cell stack. A hydrogen reactant gas flow from flow channels 28 in the bipolar plate 30 reacts with the catalyst layer 26 to dissociate the hydrogen ions and the electrons. Airflow from flow channels 32 in the bipolar plate 18 reacts with the catalyst layer 22. The hydrogen ions are able to propagate through the membrane 16 where they electro-chemically react with the oxygen in the airflow and the return electrons in the catalyst layer 22 to generate water as a by-product.

In this non-limiting embodiment, the bipolar plate 18 includes two sheets 34 and 36 that are stamped and welded together. The sheet 36 defines the flow channels 32 and the sheet 34 defines flow channels 38 for the anode side of an adjacent fuel cell to the fuel cell 10. Cooling fluid flow channels 40 are provided between the sheets 34 and 36, as shown. Likewise, the bipolar plate 30 includes a sheet 42 defining the flow channels 28, a sheet 44 defining flow channels 46 for the cathode side of an adjacent fuel cell, and cooling fluid flow channels 48. In the embodiments discussed herein, the sheets 34, 36, 42 and 44 are made of an electrically conductive material, such as stainless steel, titanium, aluminum, polymeric carbon composites, etc.

According to one embodiment of the invention, the bipolar plates 18 and 30 are coated with a metal oxide layer 50 and 52, respectively, that make the plates 18 and 30 hydrophilic. The hydrophilicity of the layers 50 and 52 causes the water within the flow channels 28 and 32 to form a film instead of water droplets so that the water does not significantly block the flow channels. Particularly, the hydrophilicity of the layers 50 and 52 decreases the contact angle of water accumulating within the flow channels 32, 38, 28 and 46, preferably below 40°, so that the reactant gas is still able to flow through the channels 28 and 32 at low loads. Suitable metal oxides for the layers 50 and 52 include, but are not limited to, silicon dioxide (SiO₂), hafnium dioxide (HfO₂), zirconium dioxide (ZrO₂), aluminum oxide (Al₂O₃), stannic oxide (SnO₂), tantalum pent-oxide (Ta₂O₅), niobium pent-oxide (Nb₂O₅), molybdenum dioxide (MoO₂), iridium dioxide (IrO₂), ruthenium dioxide (RuO₂), metastable oxynitrides, nonstoichiometric metal oxides, oxynitrides and mixtures thereof. In one embodiment, the layers 50 and 52 are thin films, for example, in the range of 5-50 nm, so that the conductivity of the sheets 34, 36, 42 and 44 still allows electricity to be effectively coupled out of the fuel cell 10.

According to another embodiment of the present invention, the metal oxide in the layers 50 and 52 is combined with a conductive oxide, such as ruthenium oxide, that increases the conductivity of the layers 50 and 52. By making the bipolar plates 18 and 30 more conductive, the electrical contact resistance and the ohmic losses in the fuel cell 10 are reduced, thus increasing cell efficiency. Also, a reduction in compression force in the stack can be provided, addressing certain durability issues within the stack.

Before the layers 50 and 52 are deposited on the bipolar plates 18 and 30, the bipolar plates 18 and 30 are cleaned by a suitable process, such as ion beam sputtering, to remove the resistive oxide film on the outside of the plates 18 and 30 that may have formed. The metal oxide material can be deposited on the bipolar plates 18 and 30 by any suitable technique including, but not limited to, physical vapor deposition processes, chemical vapor deposition (CVD) processes, thermal spraying processes and sol-gel. Suitable examples of physical vapor deposition processes include electron beam evaporation, magnetron sputtering and pulsed plasma processes. Suitable chemical vapor deposition processes include plasma enhanced CVD and atomic layer deposition processes. CVD deposition processes may be more suitable for the thin film layers 50 and 52.

FIG. 2 is a broken-away, cross-sectional view of a bipolar plate 60 including reactant gas flow channels 62 and lands 64 therebetween, according to another embodiment of the present invention. The bipolar plate 60 is applicable to replace the bipolar plate 18 or 30 in the fuel cell 10. In this embodiment, a metal oxide layer is deposited as random islands 68 on the plate 60 so that the conductive material of plate 60 is exposed at areas 70 between the islands 68. The metal oxide islands 68 provide the desired hydrophilicity of the plate 60, and the exposed areas 70 provide the desired conductivity of the plate 60. In this embodiment, the islands 68 may best be deposited by a physical vapor deposition process, such as electron beam evaporation, magnetron sputtering and pulsed plasma processes. In one embodiment, the islands 68 are deposited to a thickness between 50-100 nm.

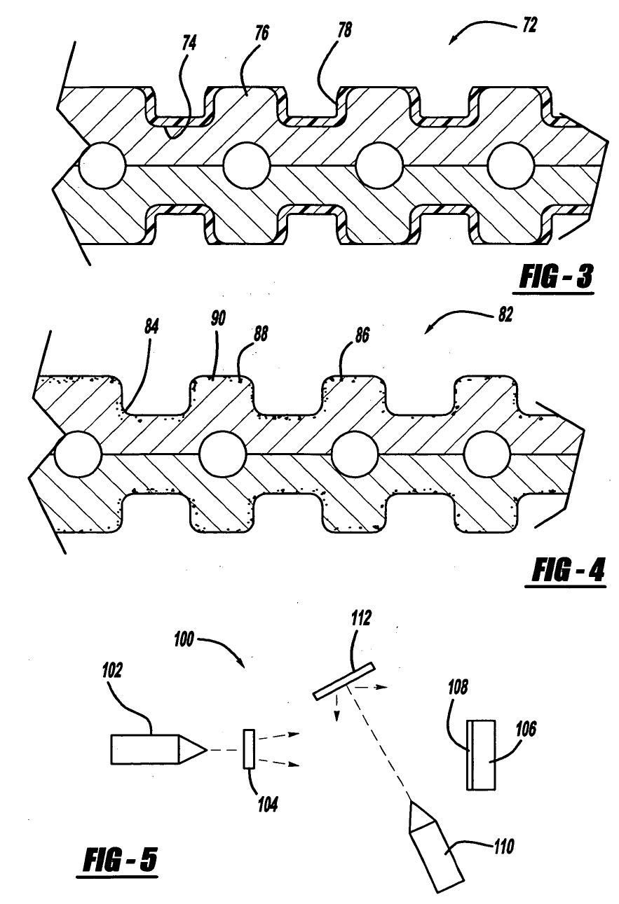

FIG. 3 is a broken-away, cross sectional view of a bipolar plate 72 including reactant gas flow channels 74 and lands 76 therebetween, according to another embodiment of the present invention. In this embodiment, a metal oxide layer 78 is deposited on the bipolar plate 72. The layer 78 is then removed over the lands 76 by any suitable process, such as polishing or grinding, to expose the conductive material of the plate 72 at the lands 76. Therefore, the flow channels 74 include the hydrophilic coating, and the lands 76 are conductive so that electricity is conducted out of a fuel cell. In this embodiment, the layer 78 can be deposited thicker than the embodiments discussed above, such as 100 nm to 1μ, because the plate 72 can be less conductive in the channels 74.

FIG. 4 is broken-away, cross-sectional view of a bipolar plate 82 including reactant gas flow channels 84 and lands 86, according to another embodiment of the present invention. In this embodiment, the bipolar plate 82 has been blasted with a metal oxide, such as alumina (Al₂O₃), so that particles 88 of the alumina are embedded in an outer surface 90 of the bipolar plate 82. Blasting of the alumina particles provides a hydrophilic material at the surface 90 of the bipolar plate 82, and increases the roughness of the surface 90 of the bipolar plate 82 to further enhance the hydrophilicity of the plate 82. Further, because the particles are embedded in the surface 90 of the plate 82, the conductivity of the plate 80 at the outer surface 90 is significantly maintained so that electricity is conducted out of the fuel cell.

FIG. 5 is a plan view of a system 100 for depositing the various layers on the bipolar plates discussed above. The system 100 is intended to represent any of the techniques mentioned above, including, but not limited to, blasting, physical vapor deposition processes, chemical vapor deposition processes, thermal spraying processes and sol-gel. In the system 100, an electron gun 102 heats a material 104 that causes the material 104 to be vaporized and deposited on a substrate 106, representing the bipolar plate, to form a coating 108 thereon. In another process, the system 100 includes an ion gun 110 that directs a beam of ions to a sputtering surface 112 that releases material, such as a metal oxide, to deposit the coating 108.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A fuel cell comprising a flow field plate being made of a conductive plate material, said flow field plate including a plurality of flow channels separated by lands where the flow channels are responsive to a reactant gas, said flow field plate further including an outer metal oxide layer that makes the flow field plate hydrophilic.

2. The fuel cell according to claim 1 wherein the plate material comprises at least one of stainless steel, titanium, aluminum, alloys thereof, and a polymer-carbon composite based material.

3. The fuel cell according to claim 1 wherein the metal oxide comprises at least one of SiO₂, HfO₂, ZrO₂, Al₂O₃, SnO₂, Ta₂O₅, Nb₂O₅, MoO₂, IrO₂, RuO₂, metastable oxynitrides, nonstoichiometric metal oxides, oxynitrides and mixtures thereof.

4. The fuel cell according to claim 1 wherein the metal oxide layer is a thin film having a thickness in the 5-50 nm range.

5. The fuel cell according to claim 1 wherein the metal oxide layer is a broken-up layer defining islands of the metal oxide with areas of exposed plate material therebetween.

6. The fuel cell according to claim 5 wherein the islands have a thickness in the range of 50-100 nm.

7. The fuel cell according to claim 1 wherein the metal oxide layer has been removed from the lands to expose the plate material at the lands so that only the flow channels include the metal oxide layer.

8. The fuel cell according to claim 1 wherein the metal oxide layer is an embedded layer including particles of the metal oxide.

9. The fuel cell according to claim 8 wherein the metal oxide is alumina.

10. The fuel cell according to claim 8 wherein the embedded layer creates a textured outer surface of the flow field plate.

11. The fuel cell according to claim 1 wherein the metal oxide is mixed with a conductive oxide.

12. The fuel cell according to claim 11 wherein the conductive oxide is ruthenium oxide.

13. The fuel cell according to claim 1 wherein the metal oxide layer is deposited on the flow field plate by a process selected from the group consisting of an electron beam evaporation process, magnetron sputtering, a pulsed plasma process, plasma enhanced chemical vapor deposition, an atomic layer deposition process, thermal spraying and sol-gel.

14. A fuel cell comprising a flow field plate being made of a conductive plate material, said flow field plate including a plurality of flow channels, said flow field plate including an embedded layer in an outer surface of the flow field plate that makes the plate hydrophilic, said embedded layer including particles of a metal oxide.

15. The fuel cell according to claim 14 wherein the metal oxide is alumina.

16. The fuel cell according to claim 14 wherein the embedded layer creates a textured outer surface of the flow field plate that increases its hydrophilicity.

17. A method for making a flow field plate for a fuel cell, said method comprising:
providing a conductive flow field plate including a plurality of flow channels separated by lands where the flow channels are responsive to a reactant gas; and
depositing an outer metal oxide layer on the plate to make the flow field plate hydrophilic.

18. The method according to claim 17 wherein depositing an outer metal oxide layer includes depositing a metal oxide comprises at least one of SiO₂, HfO₂, ZrO₂, Al₂O₃, SnO₂, Ta₂O₅, Nb₂O₅, MoO₂, IrO₂, RuO₂, metastable oxynitrides, nonstoichiometric metal oxides, oxynitrides and mixtures thereof.

19. The method according to claim 17 wherein depositing an outer metal oxide layer includes depositing a metal oxide layer as a thin film having a thickness in the 5-50 nm range.

20. The method according to claim 17 wherein depositing an outer metal oxide layer includes depositing a metal oxide layer as a broken-up layer defining islands of the metal oxide with areas of exposed plate material therebetween.

21. The method according to claim 20 wherein depositing an outer metal oxide layer includes depositing the islands to a thickness in the range of 50-100 nm.

22. The method according to claim 17 further comprising removing the metal oxide layer from the lands to expose the plate material at the lands so that only the flow channels include the metal oxide layer.

23. The method according to claim 17 wherein depositing an outer metal oxide layer includes blasting particles of the metal oxide into a top surface of the plate.

24. The method according to claim 17 wherein depositing an outer metal oxide layer includes mixing the metal oxide with a conductive oxide.

25. The method according to claim 24 wherein the conductive oxide is ruthenium oxide.

26. The method according to claim 17 wherein depositing an outer metal oxide layer includes depositing the metal oxide layer on the flow field plate by a process selected from the group consisting of an electron beam evaporation process, magnetron sputtering, a pulsed plasma process, plasma enhanced chemical vapor deposition, an atomic layer deposition process, thermal spraying and sol-gel.
